(19) United States
(12) Patent Application Publication
(10) Pub. No.: US 2017/0002538 A1
(43) Pub. Date: Jan. 5, 2017

(54) System and Method for a Telescopic Strut

(71) Applicant: Trinity Shoring Products, Inc., Dallas, TX (US)

(72) Inventors: Dennis L. PARKER, Battle Creek, MI (US); Timothy S. DEY, Union City, MI (US); Roger A. GORAS, Burlington, MI (US)

(21) Appl. No.: 15/198,685

(22) Filed: Jun. 30, 2016

Related U.S. Application Data
(60) Provisional application No. 62/186,725, filed on Jun. 30, 2015.

(51) Int. Cl. E02D 17/08; F16B 7/10

(52) U.S. Cl. CPC E02D 17/083; E02D 17/086; F16B 7/105

(57) ABSTRACT

A system for a telescopic strut includes a plurality of telescopic struts each comprising at least two hollow structural sections. Each of the plurality of telescopic struts is configured to separate a first shield wall from a second shield wall that is opposite the first shield wall. A first hollow structural section of a first telescopic strut of the plurality of telescopic struts is coupled to an overlapping second hollow structural section of the first telescopic strut by an internal retention device. The first hollow structural section and the second hollow structural section are configured to retract and extend from one another along a length of a portion of the internal retention device. The internal retention device is configured to prevent the first hollow structural section from separating from the second hollow structural section when a length of the first telescopic strut is being adjusted.

### CROSS-REFERENCE TO RELATED APPLICATIONS

This application claims the benefit under 35 U.S.C. §119(e) of U.S. Provisional Application No. 62/186,725, entitled, “SYSTEM AND METHOD FOR A TELESCOPIC STRUT,” filed on Jun. 30, 2015, the contents of which are incorporated herein in its entirety by this reference.

### TECHNICAL FIELD

The present disclosure relates generally to trench shoring, and more particularly to a system and method for a telescopic strut.

### BACKGROUND

Trench shields generally include struts, which separate opposing shield sidewalls to support the faces of a trench or excavation to prevent collapse. Because it is often desirable to adjust the distance between shield sidewalls, trench shields typically are employed using adjustable struts. Current adjustable struts include only two telescopically fitted sections and are normally fabricated in standard lengths. As a result, existing adjustable struts are limited in adjustable range due to their outer sleeve, and therefore require replacement when the desired distance between shield sidewalls exceeds the maximum length of those struts.

### BRIEF SUMMARY

The teachings of the present disclosure relate to a system and method for a telescopic strut. In accordance with one embodiment, a system for a telescopic strut includes a plurality of telescopic struts each comprising at least two hollow structural sections. Each of the plurality of telescopic struts is configured to separate a first shield wall from a second shield wall that is opposite the first shield wall. A first hollow structural section of a first telescopic strut of the plurality of telescopic struts is coupled to an overlapping second hollow structural section of the first telescopic strut by an internal retention device. The first hollow structural section and the second hollow structural section are configured to retract and extend from one another along a length of a portion of the internal retention device. The internal retention device is configured to prevent the first hollow structural section from separating from the second hollow structural section when a length of the first telescopic strut is being adjusted.

Technical advantages of particular embodiments may include providing a telescopic strut with two or more hollow structural sections that may extend and retract from one another. Such a telescopic strut may provide a broader range of length adjustments, which in turn may reduce the frequency of strut replacements.

Further technical advantages of particular embodiments may include a telescopic strut with a retention system that may prevent the two or more hollow structural sections from separating during range adjustment. For example, retention devices may prevent a telescopic strut from extending too far and/or retracting too much when adjusting a length of the telescopic strut.

Yet another technical advantage of particular embodiments may include providing an end-loadable telescopic strut for three-sided and/or four-sided protection from an excavation failure (e.g., collapse).

Other technical advantages will be readily apparent to one of ordinary skill in the art from the following figures, descriptions, and claims included herein. Moreover, while specific advantages have been enumerated above, certain embodiments of the invention may include all, some, or none of the enumerated advantages.

### BRIEF DESCRIPTION OF THE DRAWINGS

The above and other features and advantages of the invention will become apparent from a consideration of the following detailed description when reviewed in connection with the accompanying drawings, in which:

FIG. 1 illustrates a perspective view of an example system for a telescopic strut in accordance with particular embodiments;

FIGS. 2A through 2C illustrate perspective views of an end of an example trench shield of a system for a telescopic strut in accordance with particular embodiments;

FIG. 3A illustrates a perspective view of an example telescopic strut in accordance with particular embodiments;

FIG. 3B illustrates a side view of an example telescopic strut in accordance with particular embodiments;

FIG. 3C illustrates an end view of an example telescopic strut in accordance with particular embodiments;

FIGS. 4A through 4D illustrate perspective views of example hollow structural sections of a telescopic strut in accordance with particular embodiments;

FIGS. 5A and 5B illustrate a perspective view and side view, respectively, of an example retention device of a system for a telescopic strut in accordance with particular embodiments;

FIGS. 6A through 6C illustrate a perspective view, side view, and front view, respectively, of an example bracket assembly of a system for a telescopic strut in accordance with particular embodiments;

FIG. 7 illustrates a perspective view of an example of end-loadable telescopic struts in accordance with particular embodiments;

FIGS. 8A through 9B illustrate cross-section and side views of example hollow structural sections of a conventional telescopic strut;

FIGS. 10A through 11B illustrate cross-section and side views of example hollow structural sections of a telescopic strut in accordance with particular embodiments; and

FIG. 12 illustrates an example method for a telescopic strut in accordance with particular embodiments.

### DETAILED DESCRIPTION

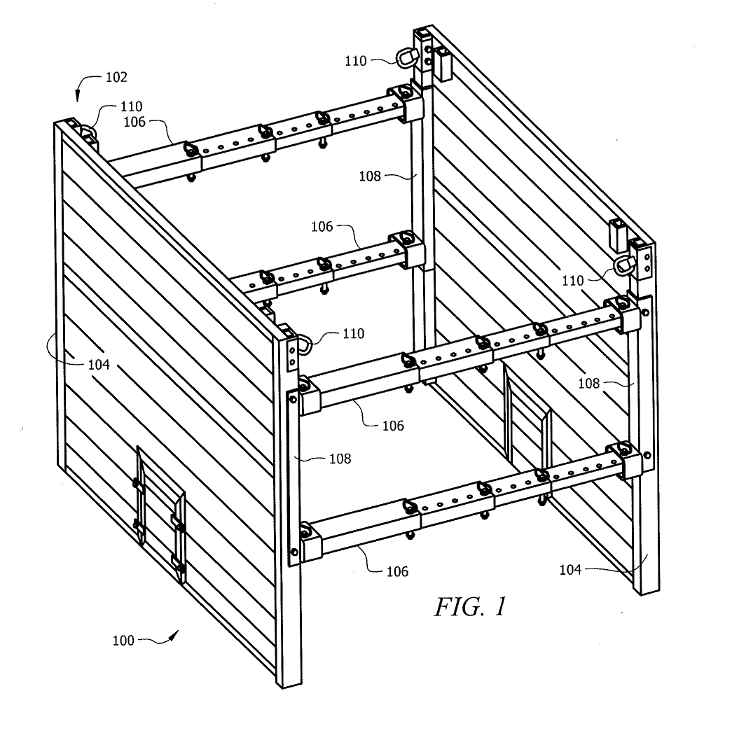

Particular embodiments and their advantages are best understood by referring to FIGS. 1 through 12 of the drawings, like numerals being used for like and corresponding parts of the various drawings.

Trench shields generally include struts, which separate opposing shield sidewalls to support the faces of a trench or excavation to prevent collapse. Because it is often desirable to adjust the distance between shield sidewalls, trench shields typically are employed using adjustable struts. Current adjustable struts include only two telescopically fitted sections and are normally fabricated in standard lengths. As a result, existing adjustable struts are limited in adjustable range due to their outer sleeve, and therefore require replacement when the desired distance between shield sidewalls exceeds the maximum length of those struts. The teachings of the present disclosure recognize that it would be desirable to provide a system and method for a telescopic strut that includes multiple hollow structural sections (e.g., four hollow structural sections) configured to extend and retract from one another and an internal and/or external retention system, thereby providing a broader range of length adjustments. FIGS. 1 through 12 below illustrate a system and method for a telescopic strut.

FIG. 1 illustrates a perspective view of an example system for a telescopic strut in accordance with particular embodiments. System 100 may include a trench shield 102, shield sidewalls 104, struts 106, bracket assemblies 108, and lifting eyes 110. In general, system 100 protects construction workers from an excavation failure (e.g., collapse).

Trench shield 102 may be used to support the faces of an excavation and protect construction workers from a collapse. Example trench shields 102 may comprise steel, aluminum, any other suitable material, and/or any combination of the preceding. In general, trench shield 102 includes shield sidewalls 104, struts 106, bracket assemblies 108, and lifting eyes 110.

Shield sidewalls 104 may refer to trench shields and may be configured to shore and/or shield the walls of an open excavation. Example shield sidewalls 104 may be made from steel, aluminum, any other suitable material, and/or any combination of the preceding. In general, shield sidewalls 104 are spaced apart from one another by struts 106. It should be understood that shield sidewalls 104 may be interchangeably referred to as shield walls.

Struts 106 may refer to adjustable/telescopic spreaders and may be used to separate opposing shield sidewalls 104 to support and/or reinforce excavation faces. In particular, struts 106 may be used space apart shield sidewalls 104 such that each shield sidewall 104 is braced against and abuts an opposing excavation face. According to the illustrated embodiment, struts 106 are coupled to and perpendicular to each shield sidewall 104. As explained in more detail below with respect to FIG. 9, in certain embodiments, struts 106 may be end-loaded for three-sided and/or four-sided protection.

Example struts 106 may be made from steel, aluminum, any other suitable material, and/or any combination of the preceding. Each strut 106 generally includes at least two telescoping hollow structural sections that slide into one another, and thus extend and retract from one another. Struts 106 in accordance with various embodiments may comprise four hollow structural sections configured to extend and retract from one another. Accordingly, the length of strut 106 may be increased or decreased, for example, to adjust the width between opposing shield sidewalls 104. It should be understood that the present disclosure contemplates strut 106 comprising any suitable number of telescoping hollow structural sections configured in any suitable manner and having any suitable shape.

As illustrated, struts 106 may be coupled to shield sidewalls 104 by bracket assemblies 108. For example, a bracket assembly 108 may be coupled to an end of a shield sidewall 104 and also coupled to an end of a strut 106, and another bracket assembly 108 may be coupled to a corresponding end of another shield sidewall 104 and also coupled to an opposing end of strut 106. In certain embodiments, a bracket assembly 108 may be coupled to each end of each shield sidewall 104. In addition, each bracket assembly 108 may be configured to couple two struts 106 to an end of a shield sidewall 104.

A bracket assembly 108 may include a plate, two brackets, and two hitch pins, and may be made of steel, aluminum, any other suitable material, and/or any combination of the preceding. A bracket may be bolted or otherwise secured to each end of a plate to form bracket assembly 108. In certain embodiments, a bracket of bracket assembly 108 may correspond to at least a portion of a strut 106 and may be configured to couple an end of strut 106 to a shield sidewall 104. In such embodiments, the bracket may comprise mounting holes for receiving a hitch pin to couple an end of a strut 106 to bracket assembly 108 (and shield sidewall 104).

Lifting eyes 110 may be used to install and remove trench shield 102 from a trench or other excavation. For example, a crane may attach to lifting eyes 110 to lower trench shield 102 into a trench. As another example, a crane may attach to lifting eyes 110 to lift trench shield 102 from a trench. As shown in FIG. 1, a lifting eye 110 may be coupled to an upper portion of each end of a shield sidewall 104.

Although FIG. 1 illustrates trench shield 102 as including two shield sidewalls 104, four struts 106, four bracket assemblies 108, and four lifting eyes 110, trench shield 102 may comprise any number of shield sidewalls 104, struts 106, bracket assemblies 108, and lifting eyes 110. Additionally, although particular examples of trench shield 102, shield sidewalls 104, struts 106, bracket assemblies 108, and lifting eyes 110 have been described, this disclosure contemplates any suitable trench shield 102, shield sidewalls 104, struts 106, bracket assemblies 108, and lifting eyes 110 comprising any suitable components configured in any suitable manner, according to particular needs. Furthermore, any component of system 100 may be integral to or separate from any other component of system 100.

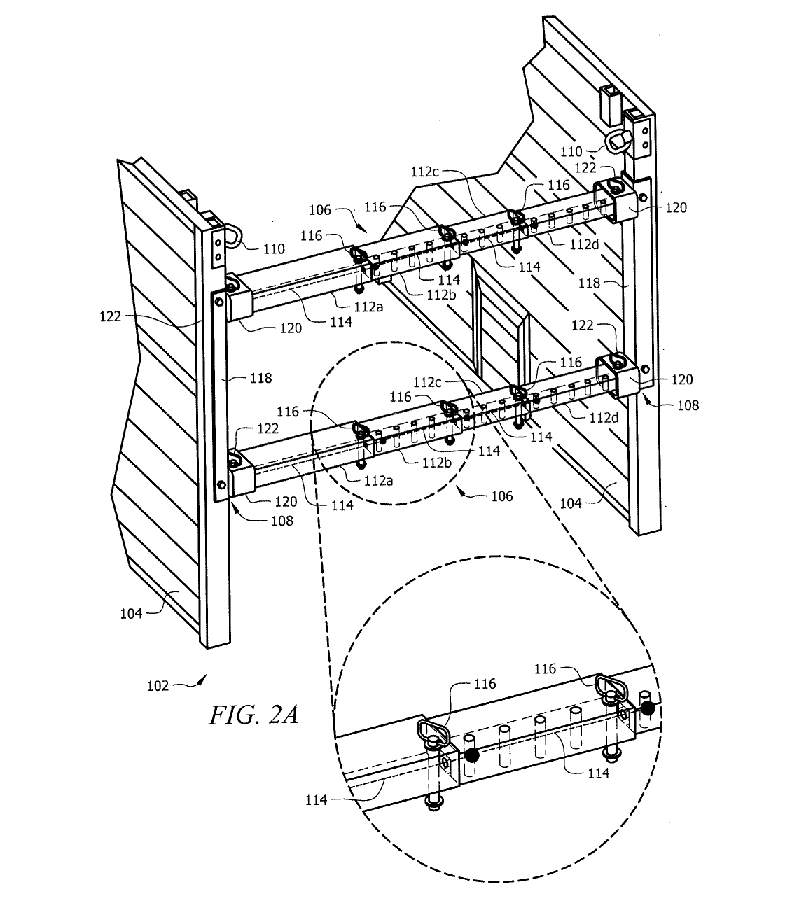

FIGS. 2A through 2C illustrate perspective views of an end of an example trench shield of a system for a telescopic strut in accordance with particular embodiments. As discussed with respect to FIG. 1, trench shield 102 may include shield sidewalls 104, struts 106, bracket assemblies 108, and lifting eyes 110.

Strut 106 generally refers to an adjustable/telescopic spreader that is configured to extend and retract (e.g., lengthen and shorten). For example, strut 106 may extended or retracted to a desired length. In certain embodiments, the length of strut 106 may range from 36 inches to 96 inches. Alternatively, the length of strut 106 may range from 24 inches to 48 inches. In certain embodiments, the length of strut 106 may range anywhere from 24 inches to 144 inches. It should be understood that the present disclosure contemplates strut 106 being any suitable length and range of lengths.

Strut 106 may include telescoping hollow structural sections 112, retention devices 114, and hitch pins 116. Hollow structural sections 112 may vary in size (e.g., height, width, and/or diameter) and be configured to extend and retract from one another such that the length of strut 106 may be adjusted. For example, hollow structural section 112b may be smaller than hollow structural section 112a and overlap with hollow structural section 112a, hollow structural section 112c may be smaller than hollow structural section 112b and overlap with hollow structural section 112b, and hollow structural section 112d may be smaller than hollow structural section 112c and overlap with hollow structural section 112c. Accordingly, hollow structural section 112d may slide into hollow structural section 112c, hollow structural section 112c may slide into hollow structural section 112b, and hollow structural section 112b may slide into hollow structural section 112a. In certain embodiments, hollow structural sections 112 may decrease in size by approximately half an inch.

In general, retention devices 114 prevent a strut 106 from extending too far or retracting too much. For example, a retention device 114 may be used to prevent a hollow structural section 112 (such as hollow structural section 112b, 112c, or 112d) from extending too far from and/or retracting too far into an adjacent hollow structural section 112 (such as hollow structural section 112a, 112b, or 112c, respectively).

Hitch pins 116 may be used to lock strut 106 at the desired length. For example, each hollow structural section 112 may include holes on each side that are spaced apart at certain distances (e.g., 4 inches). These holes may be aligned with various holes of an adjacent hollow structural section 112 and may receive hitch pins 116. In such an example, a hitch pin 116 may be inserted through the aligned holes to lock the corresponding hollow structural sections 112 in place. In certain embodiments, hitch pins 116 also may be used to prevent hollow structural sections 112 from separating from one another.

Bracket assemblies 108 are generally configured to couple struts 106 to shield sidewalls 104 and may each include a plate 118, brackets 120, and hitch pins 122. A plate 118 may be bolted or otherwise secured to each end of a shield sidewall 104, and a bracket 120 may be bolted or otherwise secured to each end of plate 118 to form a bracket assembly 108. In certain embodiments, each bracket 120 may correspond to at least a portion of a strut 106 and may be used to couple an end of strut 106 to a shield sidewall 104. In such embodiments, bracket 120 may comprise mounting holes to couple strut 106 to shield sidewall 104. For example, bracket 120 may include a mounting hole on each side to receive hitch pin 122 to attach strut 106 to shield sidewall 104.

Although FIGS. 2A through 2C illustrate strut 106 as including four hollow structural sections 112, three retention devices 114, and three hitch pins 116, strut 106 may comprise any number of hollow structural sections 112, retention devices 114, and hitch pins 116. Further, although FIGS. 2A through 2C illustrate bracket assembly 108 as including one plate 118, two brackets 120, and two hitch pins 122, bracket assembly 108 may comprise any number of plates 118, brackets 120, and hitch pins 122. Additionally, although particular examples of struts 106, bracket assemblies 108, hollow structural sections 112, retention devices 114, hitch pins 116, plates 118, brackets 120, and hitch pins 122 have been described, this disclosure contemplates any suitable struts 106, bracket assemblies 108, hollow structural sections 112, retention devices 114, hitch pins 116, plates 118, brackets 120, and hitch pins 122 comprising any suitable components configured in any suitable manner, according to particular needs. Furthermore, any component of FIGS. 2A through 2C may be integral to or separate from any other component of FIGS. 1 through 2C.

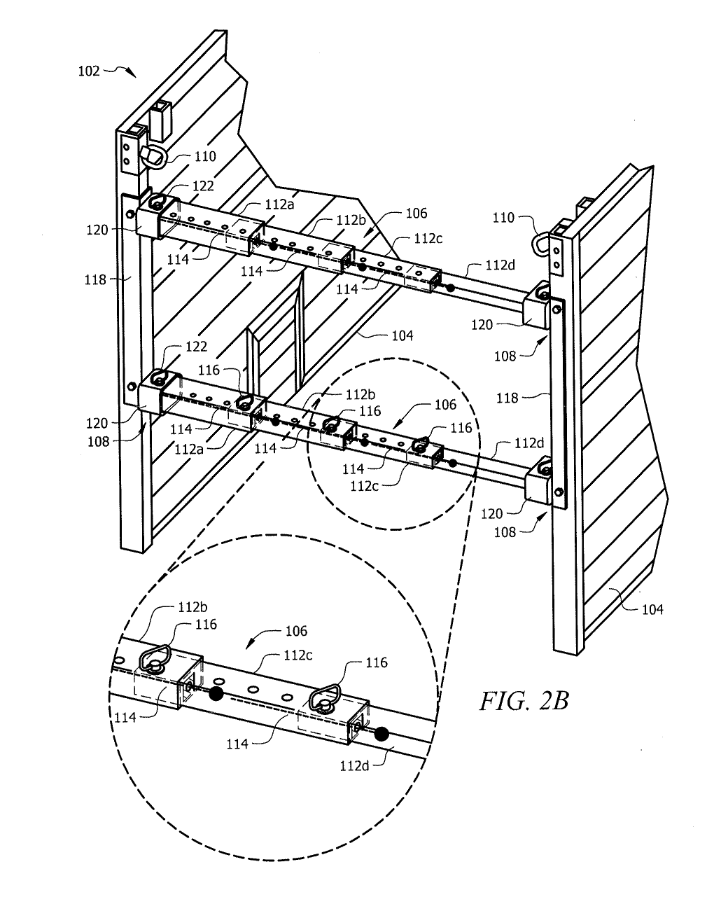

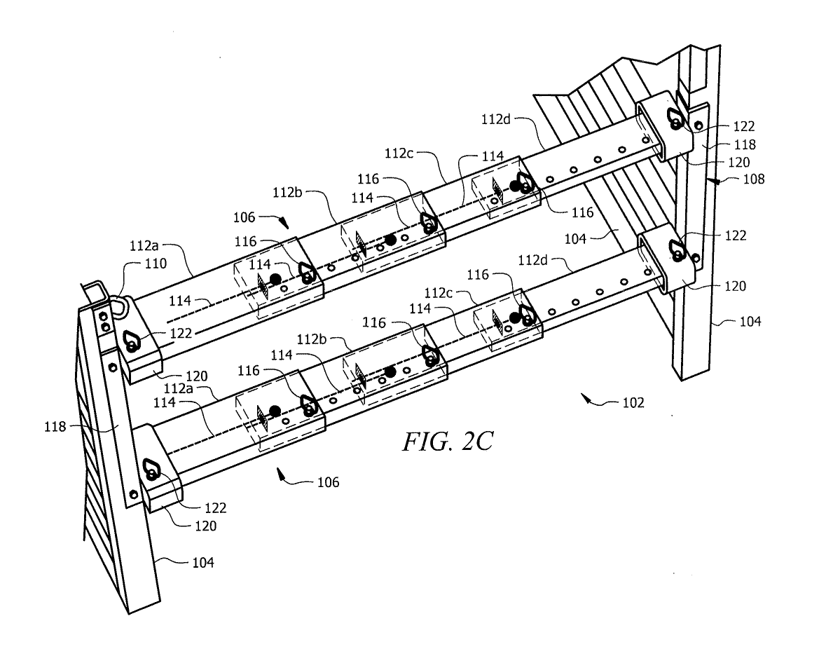

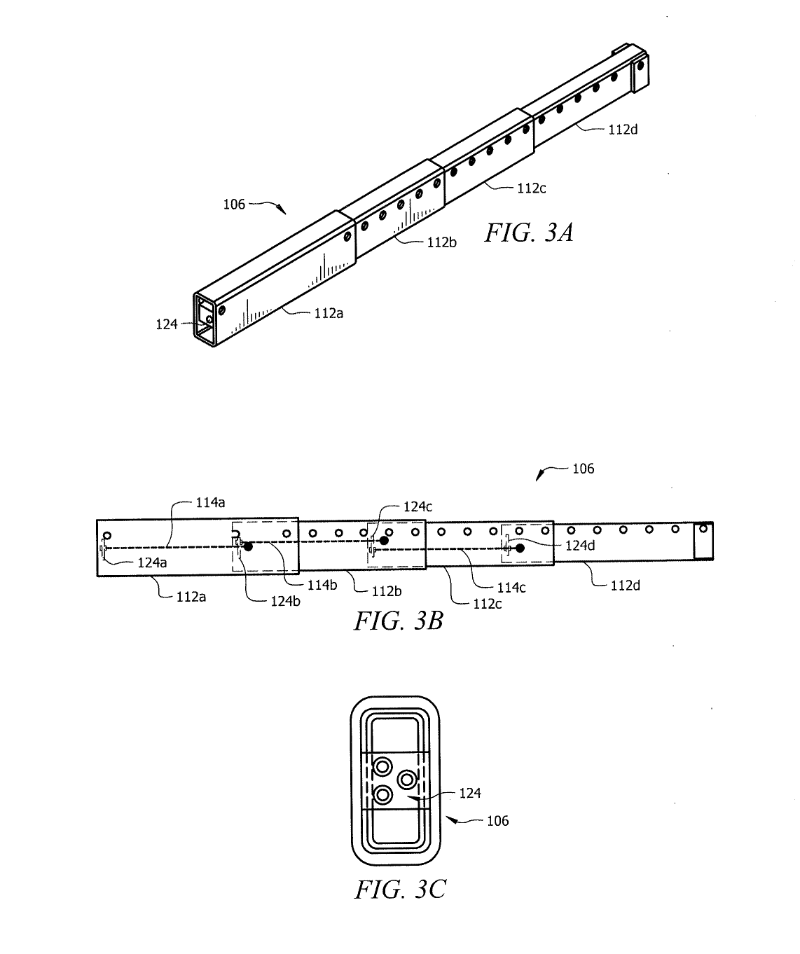

FIG. 3A illustrates a perspective view of an example telescopic strut in accordance with particular embodiments. Strut 106 may be a telescopic strut that may be adjustable in length. For example, strut 106 may have a length ranging from approximately 30 inches to 100 inches, 24 inches to 48 inches, and/or any other suitable range. According to the illustrated embodiment, strut 106 may include four hollow structural sections 112. Alternatively, strut 106 may include any other suitable number of hollow structural sections 112, such as two hollow structural sections 112, three hollow structural sections 112, five hollow structural sections 112, six hollow structural sections 112, and so on.

Hollow structural sections 112 generally vary in size and are configured to extend and retract from another. For example, hollow structural section 112b may be smaller than hollow structural section 112a, hollow structural section 112c may be smaller than hollow structural section 112b, and hollow structural section 112d may be smaller than hollow structural section 112c. Accordingly, hollow structural section 112d may telescopically fit within hollow structural section 112c, hollow structural section 112c may telescopically fit within hollow structural section 112b, and hollow structural section 112b may telescopically fit within hollow structural section 112a. As illustrated, hollow structural section 112a may overlap hollow structural section 112b, hollow structural section 112b may overlap hollow structural section 112c, and hollow structural section 112c may overlap hollow structural section 112d.

Example hollow structural sections 112 may have a rectangular shape, square shape, tubular shape, and/or any other suitable shape. In certain embodiments, each hollow structural section 112 may include openings for receiving a hitch pin 116 and/or hitch pin 122. In certain embodiments, each hollow structural section 112 also may have a length of approximately 32 inches. It should be understood that hollow structural section 112 may be any suitable length.

FIG. 3B illustrates a side view of an example telescopic strut in accordance with particular embodiments. As illustrated, strut 106 may include retention devices 114, which may be internal and/or external to strut 106. Retention devices 114 may prevent strut 106 from extending too far or retracting too much. For example, a retention device 114 (such as a retention device 114a, 114b, or 114c) may be used to prevent a hollow structural section 112 (such as a hollow structural section 112b, 112c, or 112d, respectively) from extending too far from and/or retracting too far into an adjacent hollow structural section 112 (such as hollow structural section 112a, 112b, or 112c, respectively). In certain embodiments, a retention device 114 may include one or more stoppers (e.g., one or more nuts) coupled to a first end of a rod and a bullet (or other suitable stopper) coupled to a second end of the rod.

Each retention device 114 may be coupled to an end of one hollow structural section (such as hollow structural section 112a, 112b, or 112c) by a tube stop 124, and also coupled to an end of an adjacent hollow structural section (such as hollow structural section 112b, 112c, or 112d, respectively) by another tube stop 124. As discussed in more detail below, tube stops 124 may include one or more openings for receiving and/or securing one or more retention devices 114.

One or more stoppers of a retention device 114 may be used to affix a first end of retention device 114 to a tube stop 124 (and a corresponding end of a hollow structural section 112). For example, a first stopper may be coupled to the first end of a retention device 114a on a first side of tube stop 124a, and a second stopper may be coupled to the first end of retention device 114a on an opposing side of tube stop 124a, thereby securing the first end of retention device 114a to hollow structural section 112a. In such an example, a portion of the first end of retention device 114a may pass through tube stop 124a via an opening.

A bullet of a retention device 114 may prevent a hollow structural section 112 from disjoining from an adjacent hollow structural section 112. For example, a second end of a retention device 114a may extend through one side of a tube stop 124b to an opposing side of tube stop 124b via an opening, and a bullet may be coupled to the second end of retention device 114a on the opposing side of tube stop 124b, thereby coupling retention device 114a to tube stop 124b (and hollow structural section 112b). In such an example, hollow structural section 112b may retract and extend along the length of the portion of retention device 114a that is between the stoppers of retention device 114a (and tube stop 124a) and the bullet of retention device 114a.

FIG. 3C illustrates an end view of an example telescopic strut in accordance with particular embodiments. As illustrated, hollow structural sections 112 of strut 106 may slide into one another to shorten and/or slide out from one another to extend the length of strut 106. Openings in tube stops 124 may allow retention devices 114 to pass through hollow structural sections 112 when hollow structural sections 112 are being retracted or extended.

Although FIGS. 3A through 3C illustrate strut 106 as including four hollow structural sections 112, three retention devices 114, and four tube stops 124, strut 106 may comprise any number of hollow structural sections 112, retention devices 114, and tube stops 124. For example, strut 106 may include two hollow structural sections 112, three hollow structural sections 112, five hollow structural sections 112, ten hollow structural sections 112, and so on. As another example, strut 106 may include one retention device 114, two retention devices 114, four retention devices 114, five retention devices 114, ten retention devices 114, and so on.

Additionally, although particular examples of struts 106, hollow structural sections 112, retention devices 114, and tube stops 124 have been described, this disclosure contemplates any suitable struts 106, hollow structural sections 112, retention devices 114, and tube stops 124 comprising any suitable components configured in any suitable manner, according to particular needs. For example, one or more retention devices 114 may be external to strut 106. As another example, a retention device 114 may be a hitch pin configured to pin a hollow structural section 112 to an overlapping hollow structural section 112 at a desired location, and thereby prevent hollow structural section 112 and overlapping hollow structural section 112 from separating from one another. Furthermore, any component of FIGS. 3A through 3C may be integral to or separate from any other component of FIGS. 1 through 3.

Moreover, although various components of FIGS. 3A through 3C are shown as having particular dimensions, the present disclosure contemplates the components of FIGS. 3A through 3C having any suitable dimensions. It should be understood that the illustrated dimensions are provided only as examples.

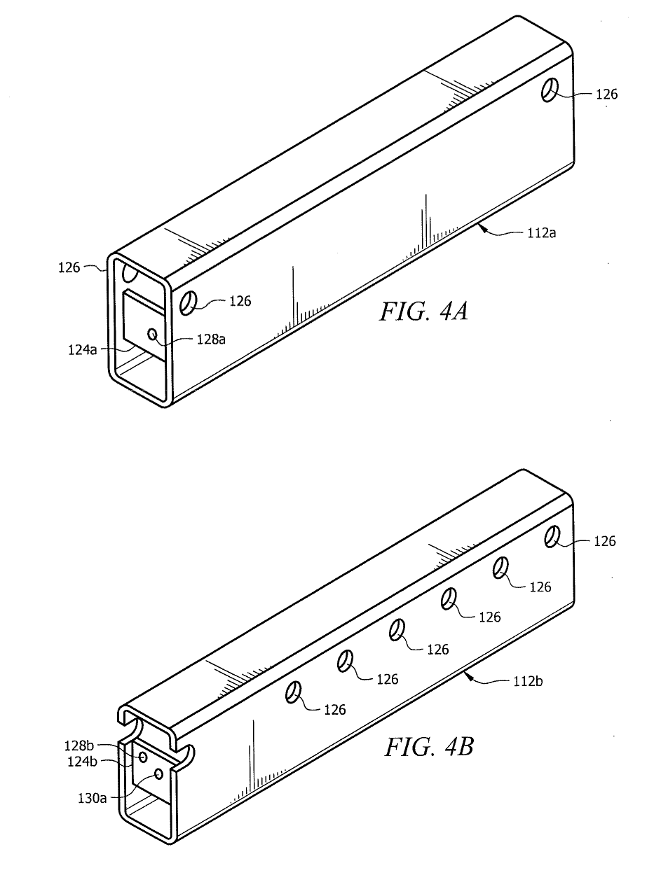

FIGS. 4A through 4D illustrate perspective views of example hollow structural sections of a telescopic strut in accordance with particular embodiments. In general, hollow structural sections 112 allow an operator to extend and retract strut 106 to various lengths. Example hollow structural sections 112 may comprise aluminum, steel, zinc, any other suitable material, and/or any combination of the preceding. In accordance with various embodiments, hollow structural sections 112 may be any suitable shape or configuration to allow strut 106 to extend and retract to various lengths. Each hollow structural section 112 may include one or more tube stops 124 and mounting holes 126.

FIG. 4A illustrates a hollow structural section 112a of a strut 106. Hollow structural section 112a may refer to an outer hollow structural section and may be larger in size than hollow structural sections 112b through 112d. In general, other hollow structural sections 112 may telescopically fit within hollow structural section 112a.

An example hollow structural section 112a may have a rectangular shape, square shape, tubular shape, and/or any other suitable shape. In certain embodiments, hollow structural section 112a may have a rectangular cross-section or any other suitable cross-section. In such embodiments, a width of hollow structural section 112a may be greater than a height of hollow structural section 112a and the width of hollow structural section 112a may be parallel to the ground when strut 106 is installed.

Hollow structural section 112a may include a tube stop 124a and mounting holes 126. Tube stop 124 may couple a first end of a retention device 114a to an end of hollow structural section 112a. For example, a portion of the first end of retention device 114a may extend through an opening 128a of tube stop 124a and be affixed to tube stop 124a by stoppers coupled to retention device 114a on opposing sides of tube stop 124a. In such an example, each stopper may be coupled to retention device 114a proximate the corresponding sides of tube stop 124a.

Mounting holes 126 may be configured to receive a hitch pin 116 and/or a hitch pin 122. For example, various mounting holes 126 may receive a hitch pin 122 to attach an end of hollow structural section 112a (and strut 106) to a shield sidewall 104. As another example, various mounting holes 126 may receive a hitch pin 116 to lock hollow structural section 112a to an adjacent/overlapping hollow structural section 112 (such as hollow structural section 112b) at a desired position.

FIG. 4B illustrates a hollow structural section 112b of a strut 106. Hollow structural section 112b may refer to an intermediate outer hollow structural section and may be smaller in size than hollow structural section 112a and larger in size than hollow structural sections 112c and 112d. In general, hollow structural section 112b may telescopically fit within hollow structural section 112a, while hollow structural sections 112c and 112d may telescopically fit within hollow structural section 112b.

An example hollow structural section 112b may have a rectangular shape, square shape, tubular shape, and/or any other suitable shape. In certain embodiments, hollow structural section 112b may have a rectangular cross-section or any other suitable cross-section. In such embodiments, a width of hollow structural section 112b may be greater than a height of hollow structural section 112b and the width of hollow structural section 112b may be parallel to the ground when strut 106 is installed.

Hollow structural section 112b may include a tube stop 124b and mounting holes 126. Tube stop 124b may couple an end of each of retention device 114a and retention device 114b to an end of hollow structural section 112b. For example, a second end of retention device 114a may extend through one side of tube stop 124b to an opposing side of tube stop 124b via an opening 130a, and a bullet may be coupled to the second end of retention device 114a on the opposing side of tube stop 124b, thereby coupling retention device 114a to tube stop 124b (and hollow structural section 112b). As another example, a portion of a first end of retention device 114b may extend through an opening 128b of tube stop 124b and be affixed to tube stop 124b by stoppers coupled to the first end of retention device 114b on opposing sides of tube stop 124b. In such an example, each stopper may be coupled to retention device 114b proximate the corresponding sides of tube stop 124b.

Mounting holes 126 may be configured to receive a hitch pin 116. For example, various mounting holes 126 may receive a hitch pin 116 to lock hollow structural section 112b to an adjacent/overlapping hollow structural section 112 (such as hollow structural section 112c) at a desired position.

FIG. 4C illustrates a hollow structural section 112c of a strut 106. Hollow structural section 112c may refer to an intermediate inner hollow structural section and may be smaller in size than hollow structural sections 112a and 112b and larger in size than hollow structural section 112d. In general, hollow structural section 112c may telescopically fit within hollow structural sections 112a and 112b, while hollow structural section 112d may telescopically fit within hollow structural section 112c.

An example hollow structural section 112c may have a rectangular shape, square shape, tubular shape, and/or any other suitable shape. In certain embodiments, hollow structural section 112c may have a rectangular cross-section or any other suitable cross-section. In such embodiments, a width of hollow structural section 112c may be greater than a height of hollow structural section 112c and the width of hollow structural section 112c may be parallel to the ground when strut 106 is installed.

Hollow structural section 112c may include a tube stop 124c and mounting holes 126. Tube stop 124c may couple an end of each of retention device 114b and retention device 114c to an end of hollow structural section 112c. For example, a second end of retention device 114b may extend through one side of tube stop 124c to an opposing side of tube stop 124c via an opening 130b, and a bullet may be coupled to the second end of retention device 114b on the opposing side of tube stop 124c, thereby coupling retention device 114b to tube stop 124c (and hollow structural section 112c). As another example, a portion of a first end of retention device 114c may extend through an opening 128c of tube stop 124c and be affixed to tube stop 124c by stoppers coupled to the first end of retention device 114c on opposing sides of tube stop 124c. In such an example, each stopper may be coupled to retention device 114c proximate the corresponding sides of tube stop 124b.

In certain embodiments, tube stop 124c may include an opening 132a that may allow retention device 114a (and the corresponding bullet) to extend into and retract out of hollow structural section 112c, for example, when the length of strut 106 is being adjusted.

Mounting holes 126 may be configured to receive a hitch pin 116. For example, various mounting holes 126 may receive a hitch pin 116 to lock hollow structural section 112c to an adjacent/overlapping hollow structural section 112 (such as hollow structural section 112d) at a desired position.

FIG. 4D illustrates a hollow structural section 112d of a strut 106. Hollow structural section 112d may refer to an inner hollow structural section and may be smaller in size than hollow structural sections 112a through 112c. In general, hollow structural section 112d may telescopically fit within hollow structural sections 112a through 112c.

An example hollow structural section 112d may have a rectangular shape, square shape, tubular shape, and/or any other suitable shape. In certain embodiments, hollow structural section 112d may have a rectangular cross-section or any other suitable cross-section. In such embodiments, a width of hollow structural section 112d may be greater than a height of hollow structural section 112d and the width of hollow structural section 112d may be parallel to the ground when strut 106 is installed.

Hollow structural section 112d may include a tube stop 124d and mounting holes 126. Tube stop 124d may couple an end of retention device 114c to an end of hollow structural section 112d. For example, a second end of retention device 114c may extend through one side of tube stop 124d to an opposing side of tube stop 124d via an opening 130c, and a bullet may be coupled to the second end of retention device 114c on the opposing side of tube stop 124d, thereby coupling retention device 114c to tube stop 124d (and hollow structural section 112d).

In certain embodiments, tube stop 124d may include openings 132a and 132b. As discussed above with regard to FIG. 4C, opening 132a may allow retention device 114a (and the corresponding bullet) to extend into and retract out of hollow structural section 112d, for example, when the length of strut 106 is being adjusted. Likewise, opening 132b may allow retention device 114b (and the corresponding bullet) to extend into and retract out of hollow structural section 112d, for example, when the length of strut 106 is being adjusted.

Mounting holes 126 may be configured to receive a hitch pin 116 and/or a hitch pin 122. For example, various mounting holes 126 may receive a hitch pin 116 to lock hollow structural section 112d to an adjacent/overlapping hollow structural section 112 (such as hollow structural section 112c) at a desired position. As another example, various mounting holes 126 may receive a hitch pin 122 to attach an end of hollow structural section 112d (and strut 106) to a shield sidewall 104.

In certain embodiments, a shim 134 may be coupled to each side of an end of hollow structural section 112d to facilitate coupling hollow structural section 112d to a shield sidewall 104. In such embodiments, shims 134 may be positioned between hollow structural section 112d and a bracket assembly 108 when hollow structural section 112d is coupled to a shield sidewall 104 via bracket assembly 108.

Although particular examples of hollow structural sections 112 have been described, this disclosure contemplates any suitable hollow structural sections 112 having any suitable shape and comprising any suitable components configured in any suitable manner, according to particular needs. Furthermore, any component of hollow structural section 112 may be integral to or separate from any other component of hollow structural section 112 and system 100.

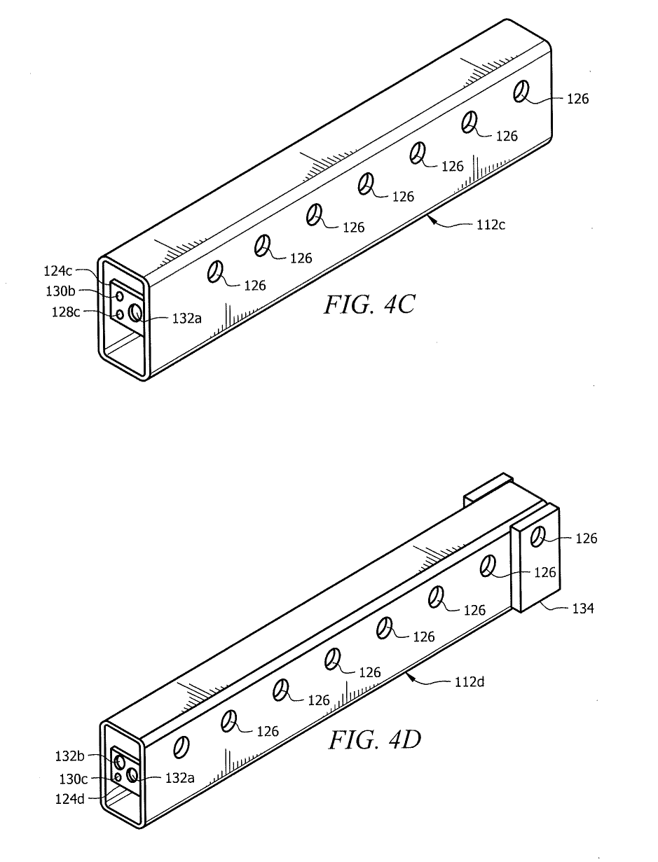

FIGS. 5A and 5B illustrate a perspective view and side view, respectively, of an example retention device of a system for a telescopic strut in accordance with particular embodiments. A retention device 114 is generally configured to prevent adjacent hollow structural sections 112 from separating from one another, for example, when the length of strut 106 is being adjusted. Retention devices in accordance with various embodiments may be any suitable shape or configuration to prevent hollow structural sections from separating.

Retention device 114 may include a rod 136, a bullet 138, and one or more stoppers 140. Example retention devices 114 may be internal and/or external to a strut 106 and may comprise steel, aluminum, zinc, any other suitable material, and/or any combination of the preceding. In certain embodiments, a retention device 114 may be approximately 24 inches long. In accordance with various embodiments, a length of a retention device 114 may range from 12 inches to 48 inches. It should be understood that the present disclosure contemplates strut 106 being any suitable length.

Rod 136 may be configured to fit through various openings of tube stops 124 and may comprise steel, aluminum, zinc, any other suitable material, and/or any combination of the preceding. In certain embodiments, the diameter of rod 136 may be smaller than the diameter of openings of tube stops 124 to allow rod 136 to extend into and retract out of hollow structural sections 112.

Bullet 138 and stoppers 140 generally facilitate preventing strut 106 from extending too far or retracting too much such that one or more hollow structural sections 112 separate from one or more adjacent hollow structural sections 112. As illustrated, a bullet 138 (or any other suitable stopper) is coupled to one end of rod 136 and one or more stoppers 140 (such as stoppers 140a and 140b) are coupled to an opposing end of rod 136.

In an example embodiment, stoppers 140 may be used to affix rod 136 (and retention device 114) to a tube stop 124 (and a corresponding hollow structural section 112). For example, stopper 140a and stopper 140b may be coupled to rod 136 of retention device 114 such that tube stop 124 is positioned between stoppers 140a and 140b. In such an example, a portion of retention device 114 may pass through tube stop 124 via an opening.

Bullet 138 may be used to couple rod 136 (and retention device 114) to an overlapping/adjacent hollow structural section 112 to prevent hollow structural section 112 from disjoining from the overlapping/adjacent hollow structural section 112. For example, another portion of retention device 114 may extend through one side of an adjacent tube stop 124 to an opposing side of adjacent tube stop 124 via an opening, and bullet 138 may be coupled to rod 136 of retention device 114 on the opposing side of adjacent tube stop 124 (and thereby coupling retention device 114 to adjacent tube stop 124 (and adjacent hollow structural section 112)). In such an example, adjacent hollow structural section 112 may retract and extend along the length of the portion of rod 136 that is between bullet 138 and stopper 140b.

Although particular examples of rod 136, bullet 138, and stoppers 140 have been described, the present disclosure contemplates any suitable rods 136, bullets 138, and stoppers 140 configured in any suitable manner and having any suitable shape, according to particular needs. In addition, any component of retention device 114 may be integral to or separate from any other component of retention device 114, strut 106, and system 100.

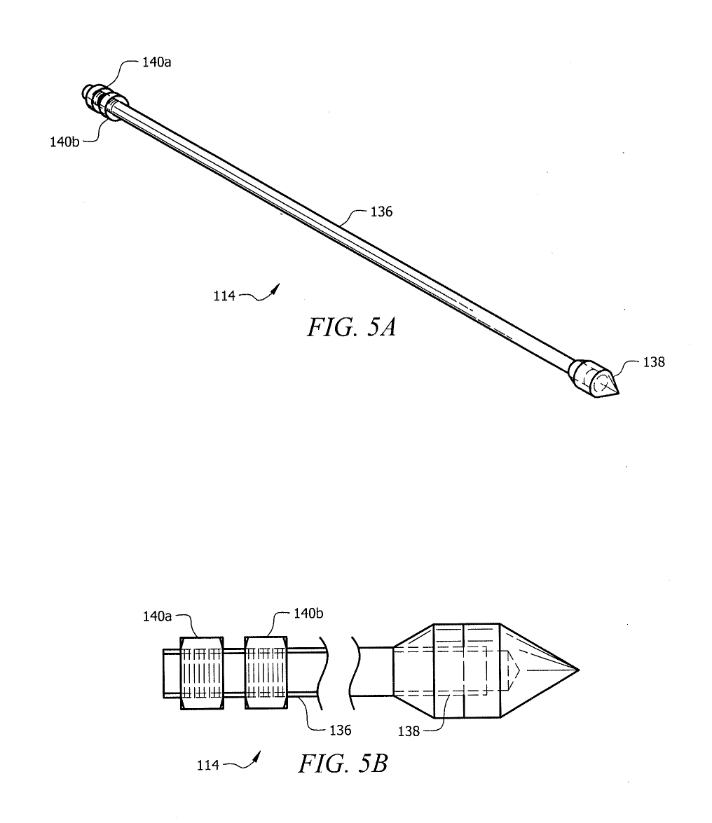

FIGS. 6A through 6C illustrate a perspective view, side view, and front view, respectively, of an example bracket assembly of a system for a telescopic strut in accordance with particular embodiments. A bracket assembly 108 may include a plate 118, brackets 120, and hitch pins 122. Example bracket assemblies 108 may comprise steel, aluminum, any other suitable material, and/or any combination of the preceding. According to the illustrated embodiment, bracket assembly 108 may be used to mount two struts 106 to a shield sidewall 104.

Plate 118 generally facilitates mounting bracket assembly 108 to a wall of a shield sidewall 104 (which may be located near an edge of shield sidewall 104). For example, plate 118 may include mounting holes 144 for bolting or otherwise securing plate 118 to a wall of shield sidewall 104. The present disclosure contemplates plate 118 being secured to a shield sidewall 104 in any suitable manner at any suitable location.

A bracket 120 may be coupled to each end of plate 118 to form bracket assembly 108. For example, each bracket 120 may be welded, bolted, or otherwise secured to an end of plate 118. In certain embodiments, bracket 120 may correspond to at least a portion of a strut 106 and may be configured to couple an end of strut 106 to a shield sidewall 104. In such embodiments, bracket may comprise mounting holes 142 for receiving a hitch pin 122 to couple an end of a strut 106 to shield sidewall 104 via bracket 120.

Hitch pin 122 may refer to any suitable locking mechanism operable to secure a strut 106 to a bracket 120. Example hitch pins 122 may be made from steel, aluminum, zinc, any other suitable material, and/or any combination of the preceding. In certain embodiments, hitch pin 122 may include a pin portion and a clip portion. The clip portion may be fastened to an end of the pin portion to keep hitch pin 122 in place.

Although FIGS. 6A through 6C illustrate bracket assembly 108 as including one plate 118, two brackets 120, and two hitch pins 122, bracket assembly 108 may comprise any number of plates 118, brackets 120, and hitch pins 122. Additionally, although particular examples of bracket assemblies 108, plates 118, brackets 120, and hitch pins 122 have been described, this disclosure contemplates any suitable bracket assemblies 108, plates 118, brackets 120, and hitch pins 122 comprising any suitable components configured in any suitable manner, according to particular needs. Furthermore, any component of bracket assembly 108 may be integral to or separate from any other component of bracket assembly 108 and FIGS. 1 through 6.

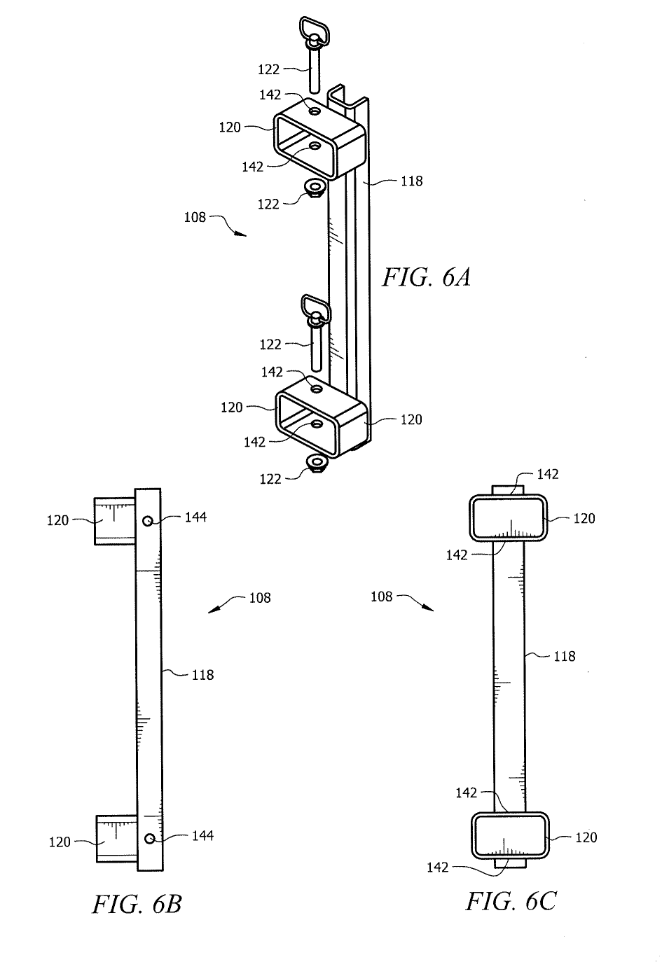

FIG. 7 illustrates a perspective view of an example of end-loadable telescopic struts in accordance with particular embodiments. Struts 106 may be configured to support a load perpendicular to one or more shield sidewalls 104. For example, a load 146 may be placed against and supported by struts 106. In other words, one or more struts 106 may be end-loaded for three-sided and/or four-sided protection (e.g., to support and/or reinforce three and/or four faces of a trench or excavation to prevent collapse).

In certain embodiments, load 146 may be a shield sidewall (such as a shield sidewall 104). Further, another load 146 (such as another shield sidewall) may be received against one or more other struts 106 on an opposing side of trench shield 102. As such, trench shield 102 may provide four-sided protection.

Although FIG. 7 illustrates trench shield 102 as including two shield sidewalls 104, four struts 106, and one load 146, trench shield 102 may comprise any number of shield sidewalls 104, struts 106, and loads 146. For example, trench shield 102 may comprise two loads 146. Additionally, although particular examples of trench shield 102, shield sidewalls 104, struts 106, and loads 146 have been described, this disclosure contemplates any suitable trench shield 102, shield sidewalls 104, struts 106, and loads 146 comprising any suitable components configured in any suitable manner, according to particular needs. Furthermore, any component of trench shield 102 may be integral to or separate from any other component of trench shield 102.

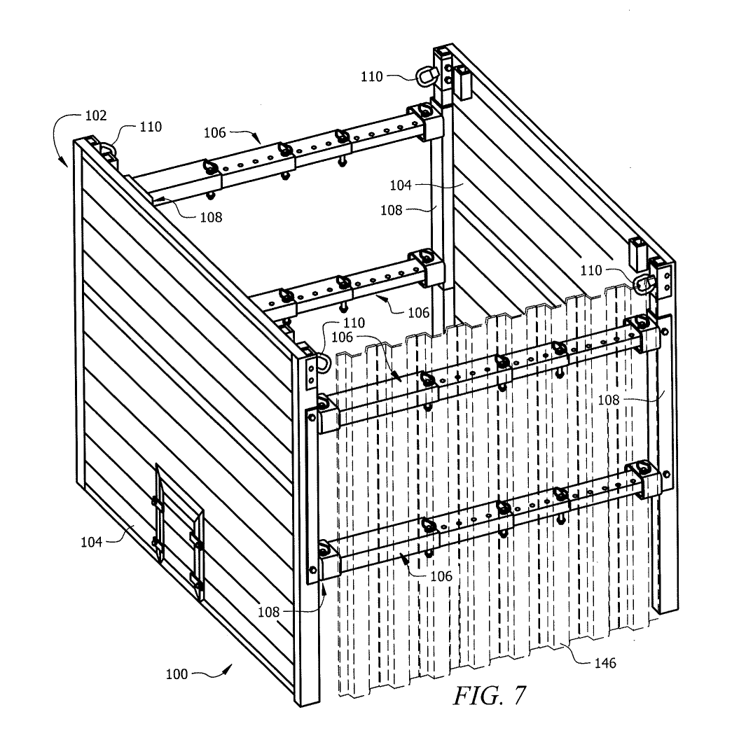

FIGS. 8A through 9B illustrate cross-section and side views of example hollow structural sections of a conventional telescopic strut. A conventional telescopic strut 200 may include hollow structural sections 202a and 202b. Hollow structural section 202b may refer to an outer hollow structural section and may be larger in size and overlap hollow structural section 202a. Hollow structural 202a may telescopically fit within hollow structural 202b.

As illustrated in FIGS. 8A and 9A, a width w₁ of hollow structural section 202a may be approximately equal to a height h₁ of hollow structural section 202a. Likewise, a width w₂ of hollow structural section 202b may be approximately equal to a height h₂ of hollow structural section 202b.

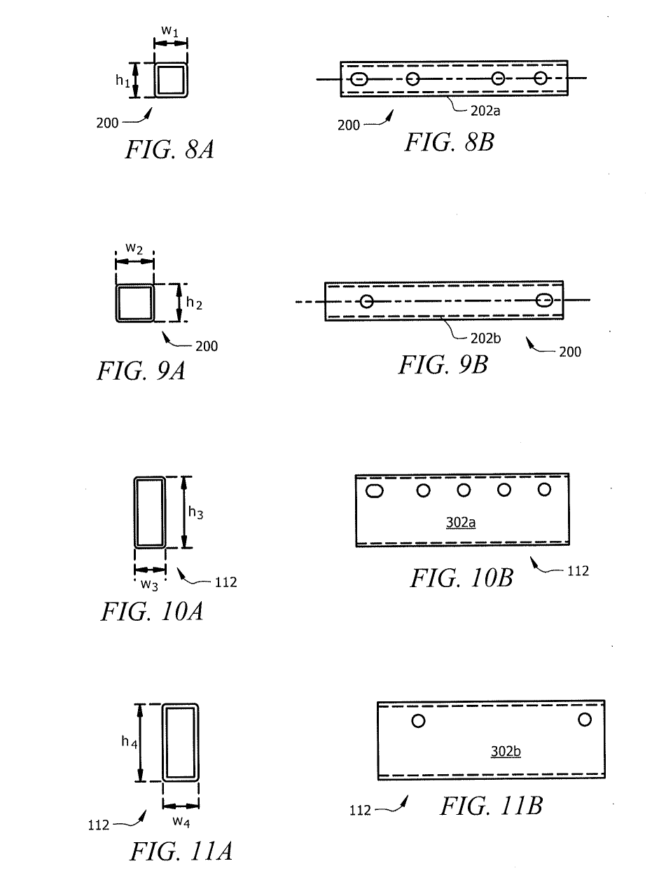

FIGS. 10A through 11B illustrate cross-section and side views of example hollow structural sections of a telescopic strut in accordance with particular embodiments. An example telescopic strut 106 of the present disclosure may include hollow structural sections 112 (such as hollow structural sections 302a and 302b). Hollow structural sections 302 of FIGS. 10A through 11B may be similar to hollow structural sections 112 of FIGS. 1 through 7. In certain embodiments, hollow structural sections 302 of strut 106 may include a greater number of mounting holes than hollow structural sections 202 of conventional strut 200.

Hollow structural sections 302 generally vary in size and are configured to retract and extend from one another. For example, hollow structural section 302b may refer to an outer hollow structural section and be larger in size and overlap hollow structural section 302a. Accordingly, hollow structural section 302a may telescopically fit within hollow structural section 302b.

As illustrated in FIGS. 10A and 11A, contrary to hollow structural sections 202 of conventional strut 200, a width w₃ of hollow structural section 302a may be greater than a height h₃ of hollow structural section 302a. Likewise, a width w₄ of hollow structural section 302b may be greater than a height h₄ of hollow structural section 302b. In addition, width w₃ of hollow structural section 302a and w₄ of hollow structural section 302b may be parallel to the ground when strut 106 is coupled to shield sidewalls (such as shield sidewalls 104 of FIGS. 1 through 2C). As such, strut 106 (and hollow structural sections 302) may be end-loaded for three-sided and/or four-sided protection.

Although FIGS. 10A through 11B illustrate strut 106 as including two hollow structural sections 302, strut 106 may comprise any number of hollow structural sections 302. For example, strut 106 may include three hollow structural sections 302, four hollow structural sections 302, five hollow structural sections 302, ten hollow structural sections 302, and so on. Additionally, although particular examples of hollow structural sections 302 have been described, this disclosure contemplates any suitable hollow structural sections 302 having any suitable shape and comprising any suitable components configured in any suitable manner, according to particular needs. Furthermore, any component of FIGS. 10A through 11B may be integral to or separate from any other component of FIGS. 1 through 7.

Moreover, although various components of FIGS. 10A through 11B are shown as having particular dimensions, the present disclosure contemplates the components of FIGS. 10A through 11B having any suitable dimensions. It should be understood that the illustrated dimensions are provided only as examples.

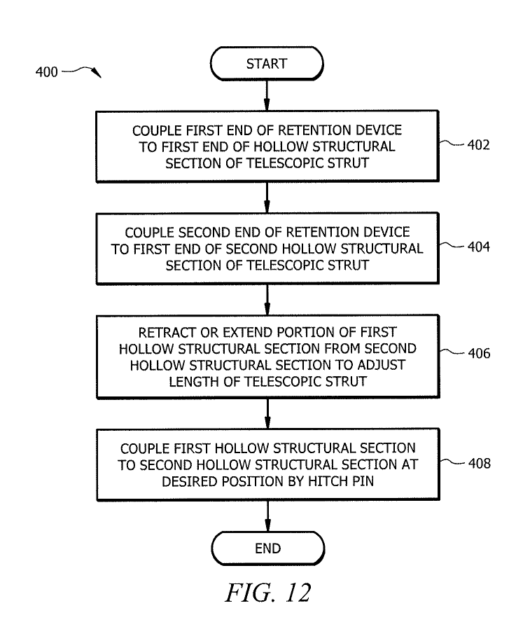

FIG. 12 illustrates an example method for a telescopic strut in accordance with particular embodiments. The method 400 begins at step 402 where a first end of a retention device (such as a retention device 114 (e.g., retention device 114a, 114b, or 114c)) is coupled to a first end of a first hollow structural section of a telescopic strut (such as a hollow structural section 112 (e.g., hollow structural section 112b, 112c, or 112d) of strut 106). In general, retention devices 114 may prevent strut 106 from extending too far or retracting too much when adjusting the length of strut 106.

At step 404, a second end of the retention device (such as the retention device 114 (e.g., retention device 114a, 114b, or 114c)) is coupled to a first end of a second hollow structural section of a telescopic strut (such as another hollow structural section 112 (e.g., hollow structural section 112a, 112b, or 112c) of strut 106). In an example embodiment, retention device 114 (such as retention device 114a, 114b, or 114c) may be used to prevent a hollow structural section 112 (such as a hollow structural section 112b, 112c, or 112d, respectively) from extending too far from and/or retracting too far into an adjacent hollow structural section 112 (such as hollow structural section 112a, 112b, or 112c, respectively). In certain embodiments, a retention device 114 may include one or more stoppers (e.g., one or more nuts) coupled to a first end of a rod and a bullet (or other suitable stopper) coupled to a second end of the rod.

Retention device 114 may be coupled to the first end of the first hollow structural section 112 (e.g., hollow structural section 112b, 112c, or 112d) by a tube stop 124, and also coupled to the first end of the second hollow structural section 112 (e.g., hollow structural section 112a, 112b, or 112c) by another tube stop 124. As discussed in more detail above, tube stops 124 may include one or more openings for receiving and/or securing one or more retention devices 114.

In certain embodiments, one or more stoppers of retention device 114 may be used to affix a first end of retention device 114 to a first tube stop 124 (and a corresponding end of the first hollow structural section 112). For example, a first stopper may be coupled to the first end of retention device 114 on a first side of first tube stop 124, and a second stopper may be coupled to the first end of retention device 114 on an opposing side of first tube stop 124, thereby securing the first end of retention device 114 to first hollow structural section 112. In such an example, a portion of the first end of retention device 114 may pass through first tube stop 124 via an opening.

A bullet of a retention device 114 may prevent a hollow structural section 112 from disjoining from an adjacent hollow structural section 112. For example, a second end of retention device 114 may extend through one side of a second tube stop 124 to an opposing side of second tube stop 124 via an opening, and a bullet may be coupled to the second end of retention device 114 on the opposing side of second tube stop 124, thereby coupling retention device 114 to second tube stop 124 (and second hollow structural section 112). In such an example, second hollow structural section 112 may retract and extend along the length of the portion of retention device 114 that is between the stoppers of retention device 114 (and first tube stop 124) and the bullet of retention device 114.

At step 406, a portion of first hollow structural section 112 may be retracted into or extended from a portion of second hollow structural section 112 to adjust a length of telescopic strut 106. For example, first and second hollow structural sections 112 of strut 106 may slide into one another to shorten and/or slide out from one another to extend the length of strut 106. Openings in tube stops 124 may allow retention devices 114 to pass through hollow structural sections 112 when hollow structural sections 112 are being retracted or extended.

At step 408, first hollow structural section 112 may be coupled to second hollow structural section 112 at a desired location by a hitch pin. In particular, a hitch pin (such as a hitch pin 116) may be used to lock strut 106 at the desired length. For example, first and second hollow structural sections 112 may include holes on each side that are spaced apart at certain distances (e.g., 4 inches). These holes may be aligned with various holes of an adjacent hollow structural section 112 and may receive hitch pins 116. In such an example, a hitch pin 116 may be inserted through the aligned holes to lock the first and second hollow structural sections 112 in place. In certain embodiments, hitch pins 116 also may be used to prevent first and second hollow structural sections 112 from separating from one another.

After step 408, the method ends.

Some of the steps illustrated in FIG. 12 may be combined, modified, or deleted where appropriate, and additional steps may also be added to FIG. 12. Additionally, steps may be performed in any suitable order without departing from the scope of the disclosure.

Teachings of the present disclosure may be satisfactorily used in a system and method for a telescopic strut. Modifications, additions, or omissions may be made to the systems described herein without departing from the scope of the present disclosure. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the present disclosure. For example, the steps may be combined, modified, or deleted where appropriate, and additional steps may be added. Additionally, the steps may be performed in any suitable order without departing from the scope of the present disclosure.

Although particular embodiments have been described herein, a myriad of changes, variations, alterations, transformations, and modifications may be suggested to one skilled in the art, and it is intended that the present disclosure encompass such changes, variations, alterations, transformations, and modifications as fall within the scope of the appended claims.

1. A system comprising:
a plurality of telescopic struts each comprising at least two hollow structural sections, each of the plurality of telescopic struts configured to separate a first shield wall from a second shield wall, the second shield wall opposite the first shield wall;
wherein a first hollow structural section of a first telescopic strut of the plurality of telescopic struts is coupled to an overlapping second hollow structural section of the first telescopic strut by an internal retention device positioned at least partially in the first hollow structural section and the second hollow structural section;
the first hollow structural section and the second hollow structural section configured to retract and extend from one another along a length of a portion of the internal retention device; and
the internal retention device configured to prevent the first hollow structural section from separating from the second hollow structural section when a length of the first telescopic strut is being adjusted.

2. The system of claim 1, wherein:
the at least two hollow structural sections of the plurality of telescopic struts are configured to extend from one another to increase the length of the a respective telescopic strut of the plurality of telescopic struts; and
the at least two hollow structural sections of the plurality of telescopic struts are configured to retract into one another to decrease the length of the respective telescopic strut of the plurality of telescopic struts.

3. The system of claim 1, wherein the at least two hollow structural sections have a rectangular cross-section.

4. The system of claim 3, wherein:
a height of each of the at least two hollow structural sections is less than a width of each of the at least two hollow structural sections; and
the width of each of the at least two hollow structural sections is parallel to ground when the plurality of telescopic struts are installed.

5. The system of claim 1, wherein the first hollow structural section of the first telescopic strut and the second hollow structural section of the first telescopic strut each comprises a plurality of mounting holes spaced apart from one another and configured to receive a hitch pin, the hitch pin configured to couple the first hollow structural section to the second hollow structural section at a desired position.

6. The system of claim 1, wherein:
a first end of the internal retention device is coupled to an end of the first hollow structural section by a first tube stop; and
a second end of the internal retention device is coupled to an end of the second hollow structural section by a second tube stop.

7. The system of claim 1, wherein the internal retention device is a first internal retention device and each of the plurality of telescopic struts further comprises:
a third hollow structural section, the third hollow structural section overlapping the second hollow structural section and coupled to the second hollow structural section by a second internal retention device; and
a fourth hollow structural section, the fourth hollow structural section overlapping the third hollow structural section and coupled to the third hollow structural section by a third internal retention device.

8. The system of claim 1, further comprising:
a first bracket assembly, the first bracket assembly configured to couple a first end of the first telescopic strut of the plurality of telescopic struts to the first shield wall; and
a second bracket assembly, the second bracket assembly configured to couple a second end of the first telescopic strut of the plurality of telescopic struts to the second shield wall.

9. The system of claim 1, wherein each of the plurality of telescopic struts is further configured to support an axial load perpendicular to the lengths of the plurality of telescopic struts.

10. The system of claim 9, wherein a source of the axial load is a third shield wall.

11. A method comprising:
separating a first shield wall from a second shield wall by a plurality of telescopic struts, the second shield wall opposite the first shield wall, each of the plurality of telescopic struts comprising at least two hollow structural sections;
wherein a first hollow structural section of a first telescopic strut of the plurality of telescopic struts is coupled to an overlapping second hollow structural section of the first telescopic strut by an internal retention device positioned at least partially in the first hollow structural section and the second hollow structural section;
wherein the first hollow structural section and the second hollow structural section is configured to retract and extend from one another along a length of a portion of the internal retention device; and
wherein the internal retention device is configured to prevent the first hollow structural section from separating from the second hollow structural section when a length of the first telescopic strut is being adjusted.

12. The method of claim 11, further comprising adjusting the length of the first telescopic strut of the plurality of telescopic struts.

13. The method of claim 12, wherein adjusting the length of the first telescopic strut comprises extending at least a portion of the first hollow structural section from at least a portion of the section hollow structural section.

14. The method of claim 12, wherein adjusting the length of the first telescopic strut comprises retracting at least a portion of the first hollow structural section into at least a portion of the second hollow structural section.

15. The method of claim 11, further comprising coupling the first hollow structural section to the second hollow structural section at a desired location by a hitch pin.

16. The method of claim 15, wherein coupling the first hollow structural section to the second hollow structural section at a desired location by the hitch pin comprises inserting the hitch pin through one of a plurality of mounting holes of the first hollow structural section and one of a plurality of mounting holes of the second hollow structural section to couple the first hollow structural section to the second hollow structural section at the desired location.

17. The method of claim 11, further comprising:
coupling a first bracket assembly to the first shield wall;
coupling a second bracket assembly to the second shield wall;
coupling a first end of the first telescopic strut to the first shield wall by coupling the first end of the first telescopic strut to the first bracket assembly; and
coupling a second end of the first telescopic strut to the second shield wall by coupling the second end of the first telescopic strut to the second bracket assembly.

18. The method of claim 11, wherein coupling the first hollow structural section to the second hollow structural section by the internal retention device comprises:
coupling a first end of the internal retention device to a first end of the first hollow structural section; and
coupling a second end of the internal retention device to a first end of the second hollow structural section.

19. The method of claim 18, wherein the internal retention device is a first internal retention device and the method further comprises:
coupling a first end of a second internal retention device to a second end of the second hollow structural section;
coupling a second end of the second internal retention device to a first end of a third hollow structural section of the first telescopic strut, the third hollow structural section overlapping the second hollow structural section, the second internal retention device configured to prevent the second hollow structural section from separating from the third hollow structural section;
coupling a first end of a third internal retention device to a second end of the third hollow structural section; and
coupling a second end of the third internal retention device to a first end of a fourth hollow structural section of the first telescopic strut, the fourth hollow structural section overlapping the third hollow structural section, the third internal retention device configured to prevent the third hollow structural section from separating from the fourth hollow structural section.

20. The method of claim 11, further comprising supporting an axial load perpendicular to the lengths of the plurality of telescopic struts.
